(19) United States
(12) Patent Application Publication
(10) Pub. No.: US 2018/0047427 A1
(43) Pub. Date: Feb. 15, 2018

(54) PLAYBACK MANAGEMENT METHODS AND SYSTEMS FOR REALITY INFORMATION VIDEOS

(71) Applicant: Bubboe Corporation, Taipei City (TW)

(72) Inventor: John C. Wang, Taipei City (TW)

(21) Appl. No.: 15/643,505

(22) Filed: Jul. 7, 2017

(30) Foreign Application Priority Data
Aug. 11, 2016 (TW) 105125539

(51) Int. Cl. G11B 27/10; H04N 13/00; H04N 9/87; G11B 27/00

(52) U.S. Cl. CPC G11B 27/10; G11B 27/005; H04N 13/0055; H04N 13/0033; H04N 9/87

(57) ABSTRACT

Playback management methods and systems for reality information videos are provided. A reality information video including a first reality information clip and a second reality information clip sequentially linked to the end of the first reality information clip is provided, wherein the second reality information clip defines specific orientation information. When the first reality information clip is played back, a first posture corresponding to the electronic device is obtained, and a first candidate reality portion is determined and displayed from the first reality information clip according to the first posture. Before the second reality information clip is played back, the specific orientation information is obtained, and a second candidate reality portion is determined and displayed from the second reality information clip according to the specific orientation information.

### BACKGROUND OF THE INVENTION

### Field of the Invention

The disclosure relates generally to playback management methods and systems for reality information videos, and, more particularly to methods and systems that can locate to specific orientation information during the playback process of a reality information video.

### Description of the Related Art

Recently, portable devices, such as smart phones or notebooks, have become more and more technically advanced and multifunctional. For example, a portable device may have network connecting capabilities. Users can use their portable devices to connect to networks anytime and anywhere. Due to increased convenience and expanded functionalities of the devices, these devices have become necessities of life.

On the other hand, VR (Virtual Reality) technology has been widely used in the fields of teaching, environment navigation, flying training, and others. VR technology uses 3D technology to simulate a 3D virtual environment. Users can use an electronic device, such as a computer or a portable device to interact with virtual objects in the environment. Generally, users can use a monitor or wear a specific electronic device to view reality information corresponding to an environment. Traditionally, the reality information is presented in a monitor using a manner of pictures. Users can use a mouse or a keyboard to control and view an environment corresponding to the reality information. Additionally, in some cases, once a specific device, such as a helmet display is worn by users, the reality information will be directly displayed in the display. Users can view the environment corresponding to the reality information via the specific device.

Currently, 360° reality information videos are very popular. A 360° reality information video is a video having a virtual reality effect. Users can use simple tools to make 360° reality information videos. Similarly, users can view the reality information videos via an electronic device, such as a smart phone or other portable device. Conventionally, a reality information video has a preset view starting orientation. When the reality information video is played back, the reality information video will be viewed from the starting orientation. Thereafter, users can change the posture of an electronic device, thus to view the reality information video in different orientations. However, in some cases, a video may have several clips, and each clip may have respective specific objects, wherein the content producer of the video expects users to view the specific objects. In conventional arts, no matter which clip of a video is played back, users may try to move an electronic device in any direction to find a specific object in a virtual environment since users do not know the absolute position/orientation of the specific object in the virtual environment. Since respective users may have different skills and familiarization with the device operating, the process for finding specific objects in a virtual environment is time-consuming, and the system performance may be influenced due to related processes. Additionally, the aimless searching process for specific objects in the virtual environment may result in users' uncomfortableness during the experience of virtual reality environments.

### BRIEF SUMMARY OF THE INVENTION

Playback management methods and systems for reality information videos are provided, wherein specific orientation information can be located during the playback process of a reality information video.

In an embodiment of a playback management method for reality information videos, a reality information video including a first reality information clip and a second reality information clip sequentially linked to the end of the first reality information clip is provided, wherein the second reality information clip defines specific orientation information. When the first reality information clip is played back, a first posture corresponding to an electronic device is obtained, a first candidate reality portion is determined from the first reality information clip according to the first posture, and the first candidate reality portion is displayed via the electronic device. Before the second reality information clip is played back, the specific orientation information is obtained, a second candidate reality portion is determined from the second reality information clip according to the specific orientation information, and the second candidate reality portion is displayed via the electronic device.

An embodiment of a playback management system for reality information videos comprises a display unit, a storage unit, and a processing unit. The storage unit comprises a reality information video including a first reality information clip and a second reality information clip sequentially linked to the end of the first reality information clip wherein the second reality information clip defines specific orientation information. When the first reality information clip is played back, the processing unit obtains a first posture corresponding to an electronic device, determines a first candidate reality portion from the first reality information clip according to the first posture, and displays the first candidate reality portion via the display unit. Before the second reality information clip is played back, the processing unit obtains the specific orientation information, determines a second candidate reality portion from the second reality information clip according to the specific orientation information, and displays the second candidate reality portion via the display unit.

In some embodiments, when the first reality information clip is played back, a target posture is determined according to the first posture of the electronic device, and the first candidate reality portion is determined from the first reality information clip according to the target posture. When the playback of the first reality information clip is complete, the specific orientation information corresponding to the second reality information clip is set as the target posture. The second candidate reality portion is determined from the second reality information clip according to the target posture, and the second candidate reality portion is displayed via the electronic device.

In some embodiments, when the playback of the first reality information clip is complete, a second posture corresponding to the electronic device is obtained, and an orientation difference is calculated according to the second posture and the specific orientation information corresponding to the second reality information clip. When the second reality information clip is played back, a third posture corresponding to the electronic device is obtained, the target posture is determined according to the third posture and the orientation difference, a third candidate reality portion is determined from the second reality information clip according to the target posture, and the third candidate reality portion is displayed via the electronic device.

In some embodiments, when the playback of the second reality information clip is complete, the orientation difference is set to 0.

In some embodiments, when the first reality information clip is played back, a target posture is determined according to the first posture corresponding to the electronic device and an orientation difference, wherein the orientation difference is preset as 0.

In some embodiments, the reality information video has a specific tag. When the playback progress of the reality information video meets the specific tag, the specific orientation information corresponding to the second reality information clip is obtained, and the target posture is set as the specific orientation information corresponding to the second reality information clip.

In some embodiments, it is determined whether a jump playback instruction is received, wherein the jump playback instruction designates any portion of the second reality information clip. When the jump playback instruction is received, in response to the jump playback instruction, the specific orientation information corresponding to the second reality information clip is obtained, a second candidate reality portion is determined from the second reality information clip according to the specific orientation information, and the second candidate reality portion is displayed via the electronic device.

In some embodiments, the specific orientation information is the orientation information of a starting orientation for first viewing the second reality information clip, or the specific orientation information is the orientation information of a specific object in the second reality information clip.

In an embodiment of a playback management method for reality information videos, a reality information video is provided, wherein the reality information video has at least one specific tag, and the specific tag corresponds to specific orientation information. When the playback progress of the reality information video meets the specific tag, the specific orientation information corresponding to the specific tag is obtained. Then, a candidate reality portion is determined from the reality information video according to the specific orientation information, and the candidate reality portion is displayed via the electronic device.

An embodiment of a playback management system for reality information videos comprises a display unit, a storage unit, and a processing unit. The storage unit comprises a reality information video, wherein the reality information video has at least one specific tag, and the specific tag corresponds to specific orientation information. The processing unit plays back the reality information video via the display unit. When the playback progress of the reality information video meets the specific tag, the processing unit obtains the specific orientation information corresponding to the specific tag, determines a candidate reality portion from the reality information video according to the specific orientation information, and displays the candidate reality portion via the display unit.

In an embodiment of a playback management method for reality information videos, a reality information video including a first reality information clip and a second reality information clip sequentially linked to the end of the first reality information clip is provided, wherein the second reality information clip defines specific orientation information. The reality information video is played back via an electronic device. It is determined whether a jump playback instruction is received, wherein the jump playback instruction designates any portion of the second reality information clip. When the jump playback instruction is received, in response to the jump playback instruction, the specific orientation information corresponding to the second reality information clip is obtained, a candidate reality portion is determined from the second reality information clip according to the specific orientation information, and the candidate reality portion is displayed via the electronic device.

An embodiment of a playback management system for reality information videos comprises a display unit, a storage unit, and a processing unit. The storage unit comprises a reality information video including a first reality information clip and a second reality information clip sequentially linked to the end of the first reality information clip, wherein the second reality information clip defines specific orientation information. The processing unit plays back the reality information video via the display unit. The processing unit determines whether a jump playback instruction is received, wherein the jump playback instruction designates any portion of the second reality information clip. When the jump playback instruction is received, in response to the jump playback instruction, the processing unit obtains the specific orientation information corresponding to the second reality information clip, determines a candidate reality portion from the second reality information clip according to the specific orientation information, and displays the candidate reality portion via the display unit.

Playback management methods for reality information videos may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a playback management system for reality information videos of the invention;

FIGS. 2A, 2B and 2C are schematic diagrams illustrating an embodiment of examples of a reality information video;

FIG. 3 is a flowchart of an embodiment of a playback management method for reality information videos of the invention;

FIG. 4 is a flowchart of another embodiment of a playback management method for reality information videos of the invention;

FIG. 5 is a flowchart of another embodiment of a playback management method for reality information videos of the invention;

FIG. 6 is a flowchart of another embodiment of a playback management method for reality information videos of the invention;

FIG. 7 is a flowchart of another embodiment of a playback management method for reality information videos of the invention; and

FIG. 8 is a flowchart of another embodiment of a playback management method for reality information videos of the invention.

### DETAILED DESCRIPTION OF THE INVENTION

Playback management methods and systems for reality information videos are provided.

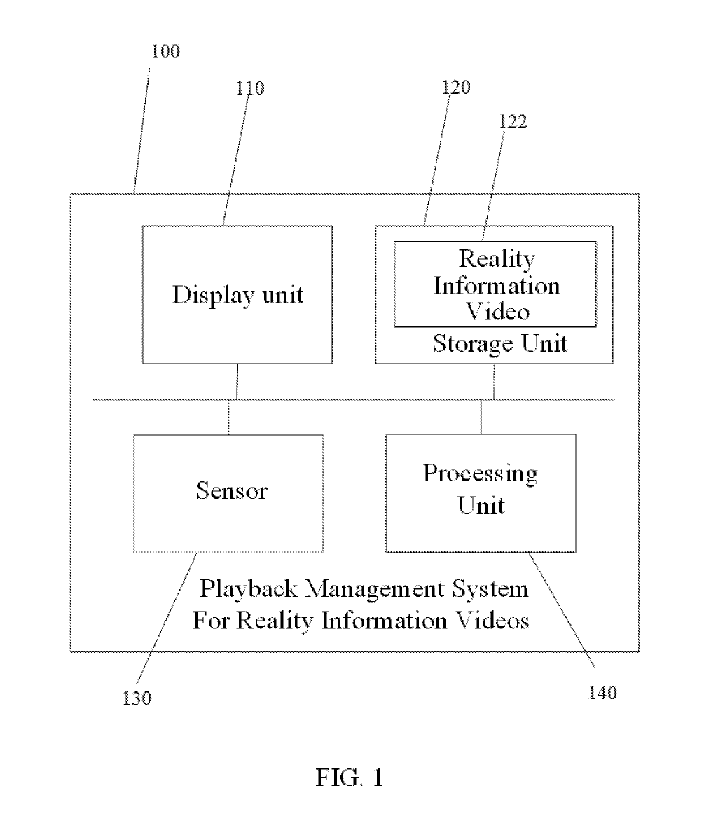

FIG. 1 is a schematic diagram illustrating an embodiment of a playback management system for reality information videos of the invention. The playback management system for reality information videos can be used in an electronic device, such as a camera, a mobile phone, a smart phone, a PDA (Personal Digital Assistant), a GPS (Global Positioning System), a wearable electronic device, a notebook, a tablet computer, or other portable device.

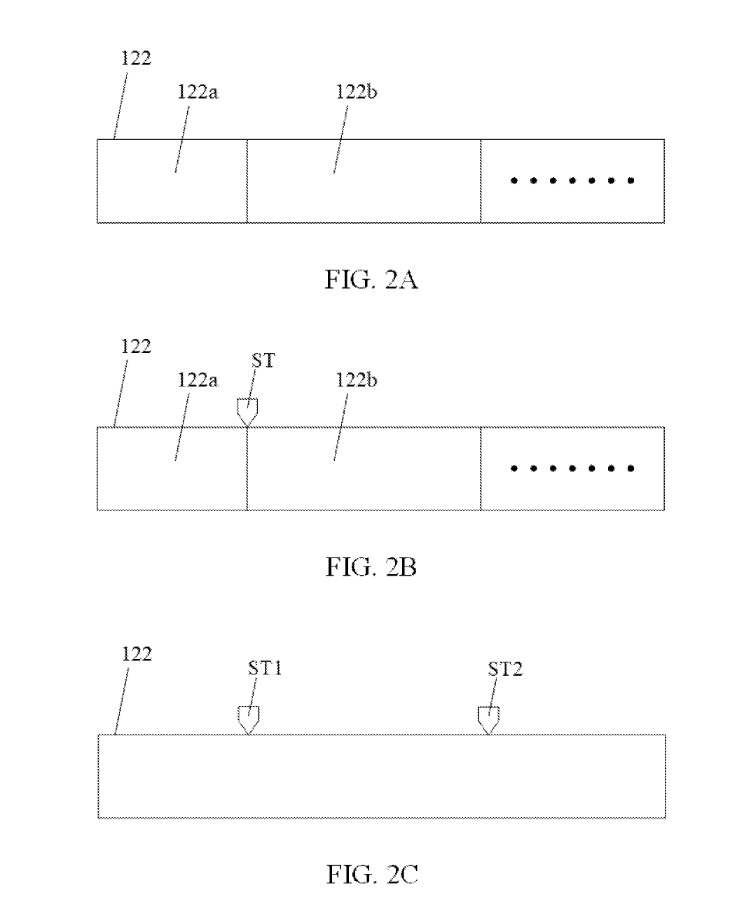

The playback management system for reality information videos 100 comprises a display unit 110, a storage unit 120, a sensor 130, and a processing unit 140. The display unit 110 can display related information, such as images, interfaces, and/or related data. It is understood that, in some embodiments, the display unit 110 may be a touch-sensitive screen. That is the display unit 110 can display data, and receive related instructions. The storage unit 120 can store related data, such as a reality information video 122. It is understood that, in some embodiments, the reality information video 122 may be a 360° reality information video. It is noted that, the reality information video 122 may be a series of images in various orientations corresponding to an environment. It is noted that, in some embodiments, the images can be used to generate the reality information video using an image stitching software. FIGS. 2A, 2B and 2C are schematic diagrams illustrating an embodiment of examples of a reality information video. In the example of FIG. 2A, the reality information video 122 includes several reality information clips, such as a first reality information clip 122a and a second reality information clip 122b, which are connected in sequence. It is understood that, in some embodiments, the reality information clips in the reality information video 122 are connected based on the same orientation basis, and the respective reality information clip can optionally define a corresponding specific orientation information. It is understood that, in some embodiments, the specific orientation information is the orientation information of a starting orientation for first viewing the reality information clip. In some embodiments, the specific orientation information is the orientation information of a specific object in the reality information clip. In the example of FIG. 2B, the reality information video 122 includes several reality information clips, such as a first reality information clip 122a and a second reality information clip 122b, which are connected in sequence. Similarly, in some embodiments, the reality information clips in the reality information video 122 are connected based on the same orientation basis. It is noted that, a tag ST can be existed between the reality information clips, and the tag ST defines a corresponding specific orientation information. Similarly, in some embodiments, the specific orientation information is the orientation information of a starting orientation for first viewing the reality information clip. In some embodiments, the specific orientation information is the orientation information of a specific object in the reality information clip. In the example of FIG. 2C, the reality information video 122 has tags, such as tags ST1 and ST2 at different time points, wherein each tag defines a corresponding specific orientation information. Similarly, in some embodiments, the specific orientation information is the orientation information of a starting orientation for viewing the reality information clip at the time point corresponding to the respective tag.

The sensor 130 can detect a motion and/or posture corresponding to an electronic device. It is understood that, in some embodiments, the posture can comprise orientation information of the electronic device, an elevation or depression angle of the electronic device, and/or a horizontal level of the electronic device. It is noted that, in some embodiments, the sensor 130 may be an accelerometer and/or a Gyro sensor. It is noted that, the above sensors are only examples of the present application, and the present invention is not limited thereto. The processing unit 140 can control related operations of hardware and software in the playback management system for reality information videos 100, and perform the playback management methods for reality information videos of the invention. It is understood that, in some embodiments, the playback management system for reality information videos 100 can comprise a network connecting unit (not shown in FIG. 1). The network connecting unit can connect to a network, such as a wired network, a telecommunication network, and a wireless network. The playback management system for reality information videos 100 can have network connecting capabilities by using the network connecting unit. It is noted that, in some embodiments, the reality information video 122 can be obtained from a network via the network connecting unit. In some embodiments, the playback management system for reality information videos 100 can comprise at least one sound output unit (not shown in FIG. 1) for outputting sounds.

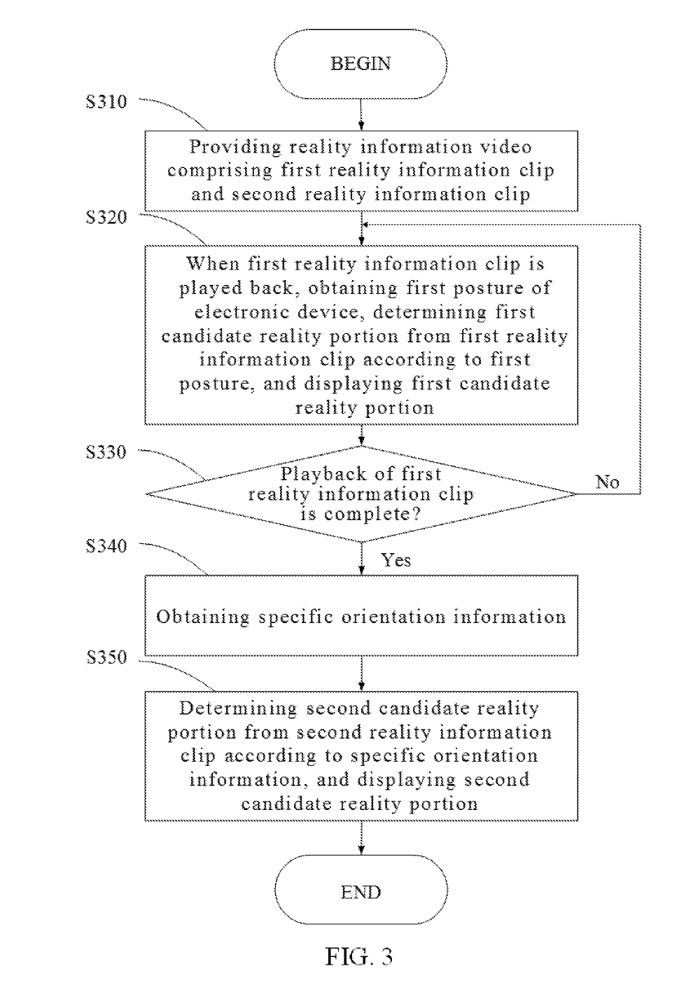

FIG. 3 is a flowchart of an embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S310, a reality information video is provided. It is understood that, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least a first reality information clip and a second reality information clip sequentially linked to the end of the first reality information clip. In some embodiments, the first reality information clip and the second reality information clip are connected based on the same orientation basis, and the second reality information clip defines a specific orientation information. It is understood that, in some embodiments, the specific orientation information is the orientation information of a starting orientation for first viewing the reality information clip. In some embodiments, the specific orientation information is the orientation information of a specific object in the reality information clip. In step S320, when the first reality information clip is played back, a first posture corresponding to an electronic device is obtained using at least one sensor, a first candidate reality portion is determined from the first reality information clip according to the first posture, and the first candidate reality portion is displayed via a display unit of the electronic device. It is understood that, in some embodiments, the posture can comprise orientation information of the electronic device, an elevation or depression angle of the electronic device, and/or a horizontal level of the electronic device. It is noted that, in some embodiments, the sensor may be an accelerometer and/or a Gyro sensor. It is noted that, the above sensors are only examples of the present application, and the present invention is not limited thereto. It is noted that, users can change the posture of the electronic device, thus to view/browse the reality information video. In step S330, it is determined whether the playback of the first reality information clip is complete. When the playback of the first reality information clip is not complete (No in step S330), the procedure returns to step S320. When the playback of the first reality information clip is complete (Yes in step S330), in step S340, the specific orientation information corresponding to the second reality information clip is obtained, and in step S350, a second candidate reality portion is determined from the second reality information clip according to the obtained specific orientation information, and the second candidate reality portion is displayed via the display unit of the electronic device.

It is understood that, in some embodiments, it is determined whether a jump playback instruction is received when the reality information video is played back by the electronic device. When the jump playback instruction is received, in response to the jump playback instruction, the specific orientation information corresponding to the second reality information clip is obtained, a second candidate reality portion is determined from the second reality information clip according to the specific orientation information, and the second candidate reality portion is displayed via the display unit of the electronic device.

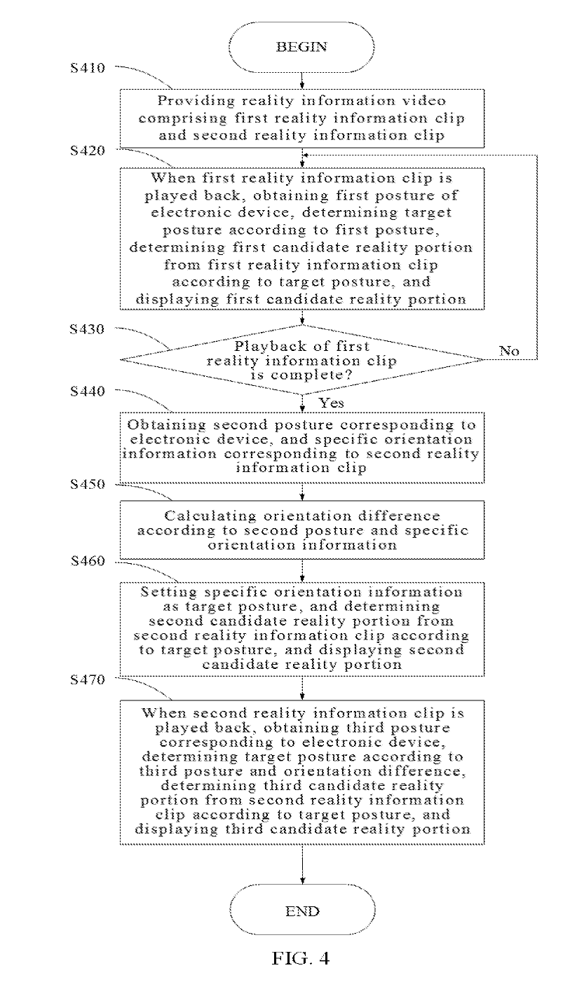

FIG. 4 is a flowchart of another embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S410, a reality information video is provided. Similarly, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least a first reality information clip and a second reality information clip sequentially linked to the end of the first reality information clip. In some embodiments, the first reality information clip and the second reality information clip are connected based on the same orientation basis, and the second reality information clip defines a specific orientation information. Similarly, in some embodiments, the specific orientation information is the orientation information of a starting orientation for first viewing the reality information clip. In some embodiments, the specific orientation information is the orientation information of a specific object in the reality information clip. In step S420, when the first reality information clip is played back, a first posture corresponding to an electronic device is obtained using at least one sensor, and a target posture is determined according to the first posture of the electronic device. It is understood that, in some embodiments, when the first reality information clip is played back, the target posture is determined according to the first posture corresponding to the electronic device and an orientation difference, wherein the orientation difference is preset as 0. A first candidate reality portion is determined from the first reality information clip according to the target posture, and the first candidate reality portion is displayed via the display unit of the electronic device. Similarly, in some embodiments, the posture can comprise orientation information of the electronic device, an elevation or depression angle of the electronic device, and/or a horizontal level of the electronic device. It is noted that, in some embodiments, the sensor may be an accelerometer and/or a Gyro sensor. It is noted that, the above sensors are only examples of the present application, and the present invention is not limited thereto. It is noted that, users can change the posture of the electronic device, thus to view/browse the reality information video. In step S430, it is determined whether the playback of the first reality information clip is complete. When the playback of the first reality information clip is not complete (No in step S430), the procedure returns to step S420. When the playback of the first reality information clip is complete (Yes in step S430), in step S440, a second posture of the electronic device and the specific orientation information corresponding to the second reality information clip are obtained, and in step S450, an orientation difference is calculated according to the second posture and the specific orientation information corresponding to the second reality information clip. Then, in step S460, the specific orientation information corresponding to the second reality information clip is set as the target posture, a second candidate reality portion is determined from the second reality information clip according to the target posture, and the second candidate reality portion is displayed via the display unit of the electronic device. Then, in step S470, when the second reality information clip is played back, a third posture corresponding to the electronic device is obtained, the target posture is re-determined according to the third posture and the orientation difference, a third candidate reality portion is determined from the second reality information clip according to the target posture, and the third candidate reality portion is displayed via the display unit of the electronic device.

Similarly, in some embodiments, it is determined whether a jump playback instruction is received when the reality information video is played back by the electronic device. When the jump playback instruction is received, in response to the jump playback instruction, the specific orientation information corresponding to the second reality information clip is obtained, a second candidate reality portion is determined from the second reality information clip according to the specific orientation information, and the second candidate reality portion is displayed via the display unit of the electronic device.

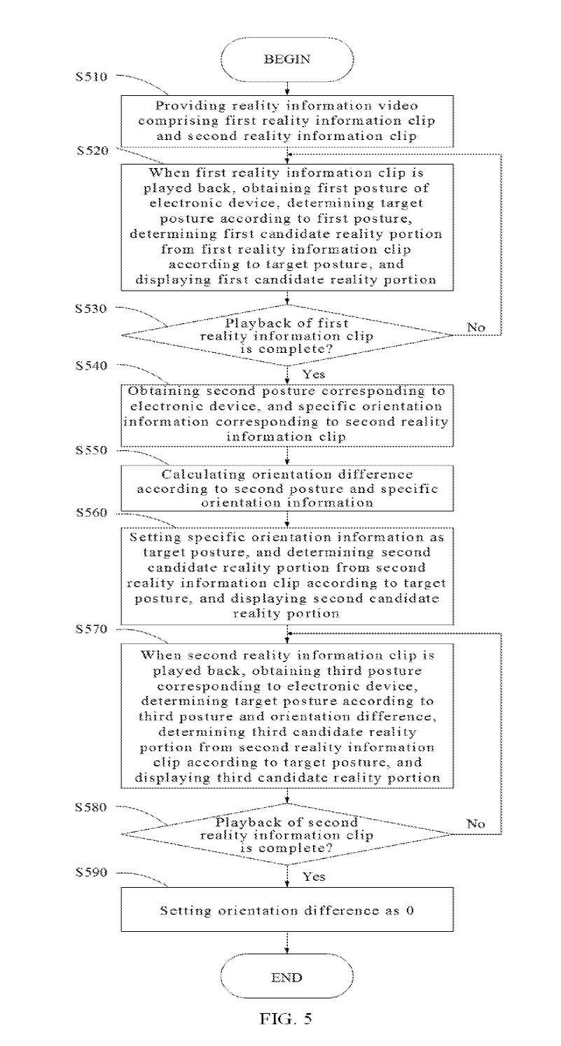

FIG. 5 is a flowchart of another embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S510, a reality information video is provided. Similarly, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least a first reality information clip and a second reality information clip sequentially linked to the end of the first reality information clip. In some embodiments, the first reality information clip and the second reality information clip are connected based on the same orientation basis, and the second reality information clip defines a specific orientation information. Similarly, in some embodiments, the specific orientation information is the orientation information of a starting orientation for first viewing the reality information clip. In some embodiments, the specific orientation information is the orientation information of a specific object in the reality information clip. In step S520, when the first reality information clip is played back, a first posture corresponding to an electronic device is obtained using at least one sensor, and a target posture is determined according to the first posture of the electronic device. Similarly, in some embodiments, when the first reality information clip is played back, the target posture is determined according to the first posture corresponding to the electronic device and an orientation difference, wherein the orientation difference is preset as 0. A first candidate reality portion is determined from the first reality information clip according to the target posture, and the first candidate reality portion is displayed via the display unit of the electronic device. Similarly, in some embodiments, the posture can comprise orientation information of the electronic device, an elevation or depression angle of the electronic device, and/or a horizontal level of the electronic device. It is noted that, in some embodiments, the sensor may be an accelerometer and/or a Gyro sensor. It is noted that, the above sensors are only examples of the present application, and the present invention is not limited thereto. It is noted that, users can change the posture of the electronic device, thus to view/browse the reality information video. In step S530, it is determined whether the playback of the first reality information clip is complete. When the playback of the first reality information clip is not complete (No in step S530), the procedure returns to step S520. When the playback of the first reality information clip is complete (Yes in step S530), in step S540, a second posture of the electronic device and the specific orientation information corresponding to the second reality information clip are obtained, and in step S550, an orientation difference is calculated according to the second posture and the specific orientation information corresponding to the second reality information clip. Then, in step S560, the specific orientation information corresponding to the second reality information clip is set as the target posture, a second candidate reality portion is determined from the second reality information clip according to the target posture, and the second candidate reality portion is displayed via the display unit of the electronic device. Then, in step S570, when the second reality information clip is played back, a third posture corresponding to the electronic device is obtained, the target posture is re-determined according to the third posture and the orientation difference, a third candidate reality portion is determined from the second reality information clip according to the target posture, and the third candidate reality portion is displayed via the display unit of the electronic device. In step S580, it is determined whether the playback of the second reality information clip is complete. When the playback of the second reality information clip is not complete (No in step S580), the procedure returns to step S570. When the playback of the second reality information clip is complete (Yes in step S580), in step S590, the orientation difference is set to 0.

Similarly, in some embodiments, it is determined whether a jump playback instruction is received when the reality information video is played back by the electronic device. When the jump playback instruction is received, in response to the jump playback instruction, the specific orientation information corresponding to the second reality information clip is obtained, a second candidate reality portion is determined from the second reality information clip according to the specific orientation information, and the second candidate reality portion is displayed via the display unit of the electronic device.

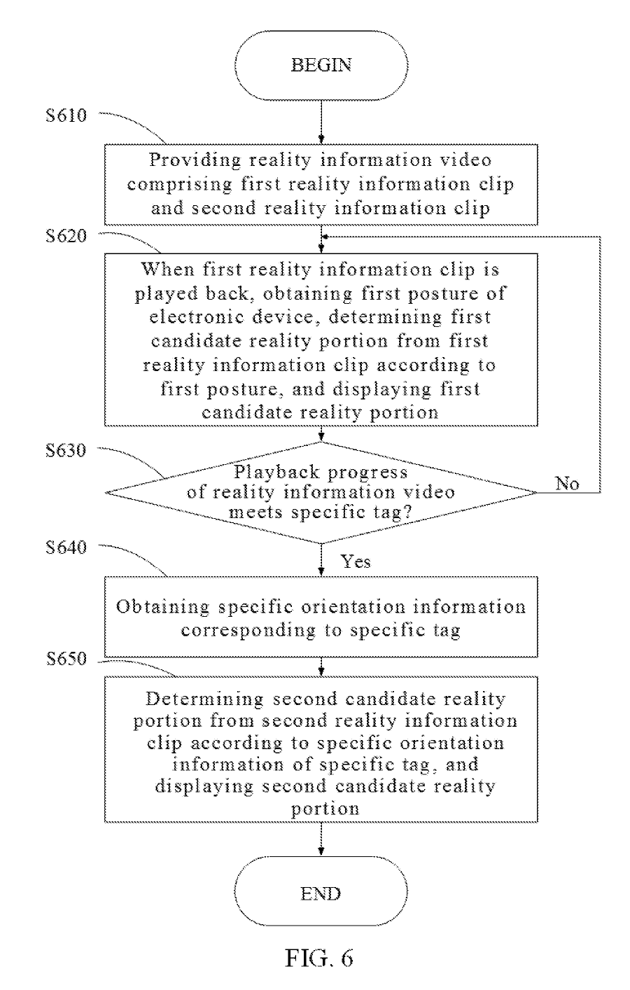

FIG. 6 is a flowchart of another embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S610, a reality information video is provided. It is understood that, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least a first reality information clip and a second reality information clip sequentially linked to the end of the first reality information clip. In some embodiments, the first reality information clip and the second reality information clip are connected based on the same orientation basis, a specific tag is existed between the reality information clips, and the specific tag defines a corresponding specific orientation information. Similarly, in some embodiments, the specific orientation information is the orientation information of a starting orientation for viewing the reality information clip. In some embodiments, the specific orientation information is the orientation information of a specific object in the reality information clip. In step S620, when the first reality information clip is played back, a first posture corresponding to an electronic device is obtained using at least one sensor, a first candidate reality portion is determined from the first reality information clip according to the first posture, and the first candidate reality portion is displayed via a display unit of the electronic device. Similarly, in some embodiments, the posture can comprise orientation information of the electronic device, an elevation or depression angle of the electronic device, and/or a horizontal level of the electronic device. It is noted that, in some embodiments, the sensor may be an accelerometer and/or a Gyro sensor. It is noted that, the above sensors are only examples of the present application, and the present invention is not limited thereto. It is noted that, users can change the posture of the electronic device, thus to view/browse the reality information video. In step S630, it is determined whether the playback progress of the reality information video meets the specific tag. When the playback progress of the reality information video does not meet the specific tag (No in step S630), the procedure returns to step S620. When the playback progress of the reality information video meets the specific tag (Yes in step S630), in step S640, the specific orientation information corresponding to the specific tag is obtained, and in step S650, a second candidate reality portion is determined from the reality information video according to the specific orientation information corresponding to the specific tag, and the second candidate reality portion is displayed via an display unit of the electronic device.

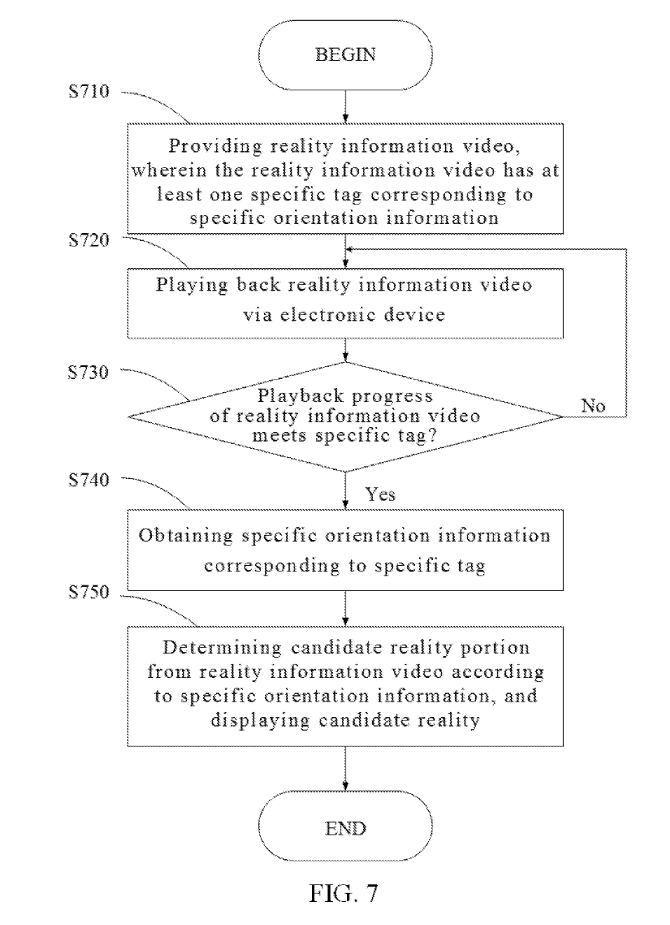

FIG. 7 is a flowchart of another embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S710, a reality information video is provided. It is understood that, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least one specific tag, which defines a corresponding specific orientation information. Similarly, in some embodiments, the specific orientation information is the orientation information of a starting orientation for viewing the reality information video. In some embodiments, the specific orientation information is the orientation information of a specific object in the reality information clip. In step S720, the reality information video is played back via a display unit of the electronic device. It is noted that, users can change the posture of the electronic device, thus to view/browse the reality information video. In step S730, it is determined whether the playback progress of the reality information video meets the specific tag. When the playback progress of the reality information video does not meet the specific tag (No in step S730), the procedure returns to step S720. When the playback progress of the reality information video meets the specific tag (Yes in step S730), in step S740, the specific orientation information corresponding to the specific tag is obtained, and in step S750, a candidate reality portion is determined from the reality information video according to the specific orientation information corresponding to the specific tag, and the candidate reality portion is displayed via the display unit of the electronic device.

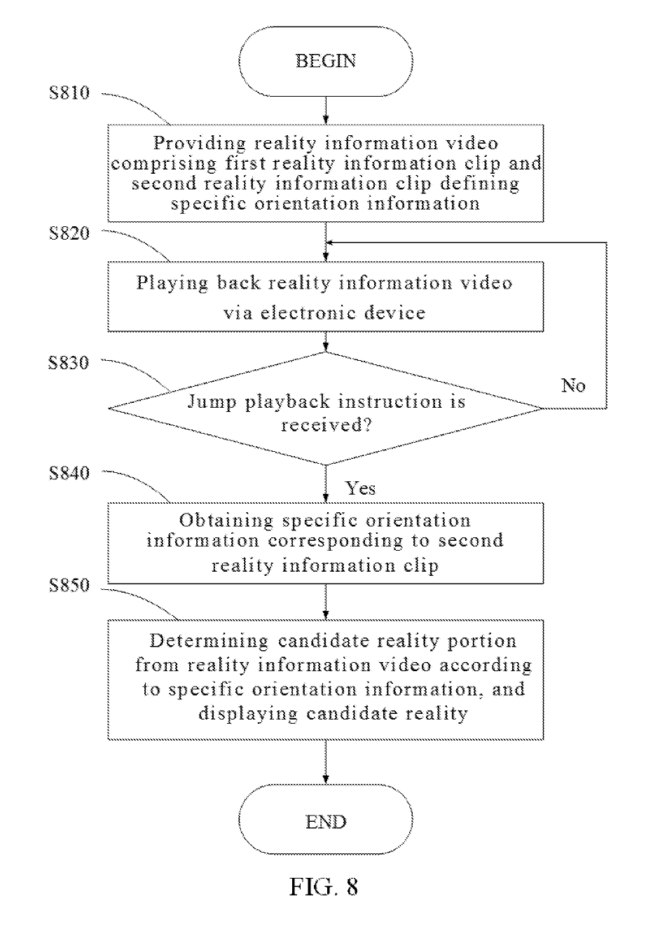

FIG. 8 is a flowchart of another embodiment of a playback management method for reality information videos of the invention. The playback management method for reality information videos can be used in an electronic device, such as a camera, a mobile phone, a smart phone, a PDA, a GPS, a wearable electronic device, a notebook, a tablet computer, or other portable device.

In step S810, a reality information video is provided. It is understood that, in some embodiments, the reality information video may be a 360° reality information video. It is noted that, the reality information video may be a series of images in various orientations corresponding to an environment. It is noted that, in some embodiments, the images can be used to generate the reality information video using an image stitching software. In the embodiment, the reality information video includes at least a first reality information clip and a second reality information clip sequentially linked to the end of the first reality information clip. In some embodiments, the first reality information clip and the second reality information clip are connected based on the same orientation basis, and the second reality information clip defines a corresponding specific orientation information. It is understood that, in some embodiments, the specific orientation information is the orientation information of a starting orientation for viewing the reality information clip. In some embodiments, the specific orientation information is the orientation information of a specific object in the reality information clip. In step S820, the reality information video is played back via a display unit of the electronic device. It is noted that, users can change the posture of the electronic device, thus to view/browse the reality information video. In step S830, it is determined whether a jump playback instruction is received, wherein the jump playback instruction designates any portion of the second reality information clip. When the jump playback instruction is not received (No in step S830), the procedure returns to S820. It is understood that, in some embodiments, users can touch a specific point on a time line corresponding to the second reality information clip via a touch-sensitive screen, thus to generate the jump playback instruction. When the jump playback instruction is received (Yes in step S830), in step S840, in response to the jump playback instruction, the specific orientation information corresponding to the second reality information clip is obtained, and in step S850, a candidate reality portion is determined from the second reality information clip according to the specific orientation information, and the candidate reality portion is displayed via the display unit of the electronic device.

Therefore, the playback management methods and systems for reality information videos of the present invention can locate specific orientation information during the playback process of a reality information video, thereby the efficiency of navigation in the virtual reality environment. Further, the users' uncomfortableness due to the aimless searching process for specific objects in the virtual environment can be reduced.

Playback management methods for reality information videos, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A playback management method for reality information videos for use in an electronic device, comprising:
providing a reality information video comprising a first reality information clip and a second reality information clip sequentially linked to the end of the first reality information clip, wherein the second reality information clip defines specific orientation information;
when the first reality information clip is played back, obtaining a first posture corresponding to an electronic device, determining a first candidate reality portion from the first reality information clip according to the first posture, and displaying the first candidate reality portion via the electronic device;
before the second reality information clip is played back, obtaining the specific orientation information; and
determining a second candidate reality portion from the second reality information clip according to the specific orientation information, and displaying the second candidate reality portion via the electronic device.

2. The method of claim 1, further comprising:
when the first reality information clip is played back, determining a target posture according to the first posture of the electronic device, and determining the first candidate reality portion from the first reality information clip according to the target posture;
when the playback of the first reality information clip is complete, setting the specific orientation information corresponding to the second reality information clip as the target posture;
determining the second candidate reality portion from the second reality information clip according to the target posture, and displaying the second candidate reality portion via the electronic device.

3. The method of claim 2, further comprising:
when the playback of the first reality information clip is complete, obtaining a second posture corresponding to the electronic device, and calculating an orientation difference according to the second posture and the specific orientation information corresponding to the second reality information clip; and
when the second reality information clip is played back, obtaining a third posture corresponding to the electronic device, determining the target posture according to the third posture and the orientation difference, determining a third candidate reality portion from the second reality information clip according to the target posture, and displaying the third candidate reality portion via the electronic device.

4. The method of claim 3, further comprising setting the orientation difference to 0 when the playback of the second reality information clip is complete.

5. The method of claim 2, further comprising determining a target posture according to the first posture corresponding to the electronic device and an orientation difference when the first reality information clip is played back, wherein the orientation difference is preset as 0.

6. The method of claim 1, wherein the reality information video has a specific tag, and when the playback progress of the reality information video meets the specific tag, the specific orientation information corresponding to the second reality information clip is obtained, and the target posture is set as the specific orientation information corresponding to the second reality information clip.

7. The method of claim 1, further comprising:
determining whether a jump playback instruction is received, wherein the jump playback instruction designates any portion of the second reality information clip;
when the jump playback instruction is received, in response to the jump playback instruction, obtaining the specific orientation information corresponding to the second reality information clip; and
determining a second candidate reality portion from the second reality information clip according to the specific orientation information, and displaying the second candidate reality portion via the electronic device.

8. The method of claim 1, wherein the specific orientation information is the orientation information of a starting orientation for first viewing the second reality information clip, or the specific orientation information is the orientation information of a specific object in the second reality information clip.

9. A playback management system for reality information videos for use in an electronic device, comprising:
a display unit;
a storage unit comprising a reality information video comprising a first reality information clip and a second reality information clip sequentially linked to the end of the first reality information clip, wherein the second reality information clip defines specific orientation information; and
a processing unit, when the first reality information clip is played back, obtaining a first posture corresponding to an electronic device, determining a first candidate reality portion from the first reality information clip according to the first posture, and displaying the first candidate reality portion via the display unit, before the second reality information clip is played back, obtaining the specific orientation information, and determining a second candidate reality portion from the second reality information clip according to the specific orientation information, and displaying the second candidate reality portion via the display unit.

10. A machine-readable storage medium comprising a computer program, which, when executed, causes a device to perform a playback management method for reality information videos for use in an electronic device, wherein the method comprises:
providing a reality information video comprising a first reality information clip and a second reality information clip sequentially linked to the end of the first reality information clip, wherein the second reality information clip defines specific orientation information;
when the first reality information clip is played back, obtaining a first posture corresponding to an electronic device, determining a first candidate reality portion from the first reality information clip according to the first posture, and displaying the first candidate reality portion via the electronic device;
before the second reality information clip is played back, obtaining the specific orientation information; and
determining a second candidate reality portion from the second reality information clip according to the specific orientation information, and displaying the second candidate reality portion via the electronic device.
